(19) United States
(12) Patent Application Publication
(10) Pub. No.: US 2026/0337508 A1
(43) Pub. Date: Oct. 29, 2026

(54) BRIQUETTE, ITS PRODUCTION PROCESS, AND, USE

(71) Applicants: SENAI-SERVICO NACIONAL DE APRENDIZAGEM INDUSTRIAL, Campo Grande (BR); TUPY S.A., Joinville (BR)

(72) Inventors: LUCIANO DONIZETI VARANDA, Três Lagoas (BR); HÉLIO MERÁ DE ASSIS, Três Lagoas (BR); LAYSSA ALINE OKAMURA, Três Lagoas (BR); LEANDRO DA CONCEIÇÃO, Curitiba (BR); FRANCIÉLI BORGES DE OLIVEIRA, Três Lagoas (BR); FELIPE WALLYSSON FERREIRA DE OLIVEIRA, Três Lagoas (BR); LUCIANA ASSIS GOBO, São Paulo (BR); RAFAEL BRISOLLA OBARA, Joinville (SC); ANDRE FERRARESE, Jundiaí (BR); ANDRÉ RIBEIRO DE SOUZA LIMA, Joinville (BR)

(21) Appl. No.: 19/656,600

(22) Filed: Apr. 23, 2026

(30) Foreign Application Priority Data
Apr. 24, 2025 (BR) 1020250080621

(51) Int. Cl. C10L 5/44

(52) U.S. Cl. CPC C10L 5/447; C10L 2200/0272; C10L 2290/02; C10L 2290/24; C10L 2290/30

(57) ABSTRACT

This invention relates to a high-performance briquette comprising biochar and a binder containing discarded sand from the foundry industry as part of its composition. The invention also relates to the production process of this briquette and its applications, mainly in the total or partial replacement of coke in industrial processes.

### FIELD OF INVENTION

This invention relates to the field of engineering, industry and renewable energy and deals with a high-performance briquette produced from biomaterials. The invention also relates to the production process of said briquette and its use in various industries including, but not limited to, foundries, steelmaking, non-ferrous materials industries, cement industries, thermal power plants, biofuel and power generation industries.

### BACKGROUND OF THE INVENTION

The concept of decarbonizing industrial processes, especially in the foundry industry, is very much present today. In this context, high-performance briquettes made from biomaterials are gaining prominence and are emerging as a promising alternative to fossil fuels due to their numerous advantages, including their renewability, reduction of greenhouse gas emissions and accessibility.

High-performance briquettes made from biomaterials are a type of solid fuel made from organic materials such as agricultural waste, forestry waste, sawdust and other biomass waste. It is produced by compressing and densifying these materials into briquettes, which have a high energy content and can be used as a substitute for traditional fossil fuels such as coal. These briquettes are considered a renewable and sustainable energy source, as they are made from waste that would otherwise be discarded or burned, contributing to air pollution and greenhouse gas emissions.

High-performance briquettes can be made from a variety of organic materials, such as sawdust, wood chips, agricultural waste, forestry waste and other biomass waste. The choice of raw material will depend on its availability, cost and the desired characteristics of the briquettes.

In addition, foundry processes generate waste that must later be disposed of, such as discarded foundry sands (ADF). These are derived from the manufacturing process of cast parts, such as core sand, molding sand, green sand, black sand, dust removal sand, sweeping sand, among other sands, which are classified according to NBR 10004 as class II—non-hazardous, free from mixing with any other residue or material foreign to the process that alters its characteristics. The reuse of these sands in the composition of briquettes was also an objective of the invention, as will be described throughout this text.

Several studies exist in the state of the art on different formulations of biochar briquettes for application in industry. The document “Potential for Developing Biocarbon Briquettes for Foundry Industry” by Elsayed Mousa, Mania Kazemi, Mikael Larsson, Gert Karlsson and Erik Persson, for example, refers to a study on replacing foundry coke with alternative renewable carbon sources. The study aimed to design, optimize, and develop biocarbon-containing briquettes, that is, biocarbon briquettes, for efficient use in cupola furnaces. However, the study did not use ADF as one of the binders for the briquettes and the total composition of the briquettes is quite different from the composition of this application.

The document “Mechanical strength of briquettes for use in blast furnaces” by Leandro Rocha Lemos, Saulo H. Freitas Seabra da Rocha, Luiz Fernando Andrade de Castro, Guilherme Bougleux Michelin Assungao and Guilherme Liziero Ruggio da Silva refers to research driven by the demand for sustainable materials in the steel industry and the search for alternatives to traditional iron-based fillers used in steelmaking. It investigates the influence of using organic and inorganic binders, blast furnace dust and sludge on the mechanical strength of briquettes for use in blast furnaces. However, the study did not use ADF as one of the binders for the briquettes and the total composition of the briquettes is quite different from the composition of this application.

The document “A Study on Densification and CO₂ Gasification of Biocarbon” by Liang Wang, Fredrik Buvarp, Øyvind Skreiberg, Pietro Bartocci and Francesco Fantozzi provides a study on woody biocarbon, which was compressed into briquettes using two different binders, starch and lignin. However, the study does not include the use of ADF as one of the binders for the briquettes and the total composition of the briquettes is different from that of this application.

As explained above, there are state-of-the-art efforts dedicated to decarbonizing industrial processes through the production of briquettes involving biomaterials. However, there is still a need for a high-performance briquette that can totally or partially replace mineral coke in industrial processes and transform an environmental liability into an economic asset, while maintaining its mechanical strength and without compromising its calorific functions.

As will be detailed below, this invention aims to solve the problems of the state of the art described above in a practical and efficient way.

### SUMMARY OF THE INVENTION

This invention relates to a high-performance briquette for the total or, usually, partial replacement of coke (of fossil origin) in industrial processes, with a composition adjusted to reuse discarded foundry sand as one of its binders. The discarded foundry sand is able to guarantee the briquette's mechanical strength without compromising its calorific functions, presenting optimum performance and combustion characteristics.

The invention also relates to the production process of said briquette and its use in various sectors of industry.

The aforementioned objectives and other advantages of this invention will become clearer from the following description.

### DETAILED DESCRIPTION OF THE INVENTION

The aim of this invention is to provide a briquette produced from biomaterials that will meet the existing need in the state of the art for a high-performance briquette that can totally or partially replace coke in industrial processes, thus transforming an environmental liability into an economic asset without loss of mechanical properties and calorific functions.

Thus, a high-performance briquette produced from biomaterials including, but not limited to, sawdust, wood chips, agricultural waste, forestry waste and other biomass waste is provided, with biochar being preferred.

The biochar briquette presents advantages and particular characteristics that are capable of solving the problems of the art pointed out above, namely: i) it enables the decarbonization of industrial processes, such as foundry processes, with the total or partial replacement of fossil fuel (coke) by a renewable biofuel (briquettes of the present invention produced from biochar derived from biomass); ii) it presents physical-chemical, mechanical and combustion performances that are at least similar to, and often superior to, prior art briquettes (such as a briquette of coke fines, anode fines and cement); iii) circular economy in the foundry process with the use of foundry sand waste as one of the binders of the briquette, that is, transforming an environmental liability (the need to dispose of foundry sand waste in landfills) into an economic asset (part of the foundry sand waste will be used as one of the binders of the briquette of the present invention); iv) it reduces the cost of briquette production by using discarded foundry sand, along with the possibility of using different biomasses, including waste biomass, composing a formulation with more than 80% of the raw material coming from waste; and v) it has great potential to totally or partially replace coke, with partial replacement of approximately 1 to approximately 80%, approximately 1 to approximately 50%, or approximately 1 to approximately 25%, in foundry processes, in addition to having potential for use in several other industrial sectors, such as: in steelmaking (in blast furnaces of iron and steel industries), in non-ferrous materials industries, cement industries, thermal power plants, industries in the biofuel sector and energy generation.

Specifically regarding the foundry industry, mainly for application in cupola furnaces used for the production of cast iron, it is important to ensure, in addition to calorific value, the mechanical resistance of the briquette, since it must withstand the descent of the charge, resist being placed in the furnace, resist the entry of the material to be melted, withstanding both impact stress (introduction of the material) and compression stress (resistance of the coke bed) so that the molten metal can flow between the coke or briquette, capturing carbon for the formation of the alloy, so that it can perform the function of replacing mineral coke. With the briquette formulation of the present invention, using discarded foundry sand residue as a binder, it is possible to develop a briquette with the necessary characteristics to perform this function, having adequate mechanical strength, calorific value and fixed carbon (examples of suitable characteristics may be: Mechanical strength: 2.5 to 5 MPa, Ash: 3 to 15%, Fixed carbon: 60 to 90%, Combustibility index: 5 to 12 MJ/kg, PCS: 6000 to 7500 kcal/kg). Furthermore, the possibility of using different types of biomass, including forest residues, combined with the use of ADF and starch, reduces the manufacturing cost of this briquette, making it an innovative and economically attractive option to replace coke. It also provides for the circularity of materials and the sustainability of the foundry chain.

In order to achieve the objectives described above, the present invention provides a briquette specifically comprising: from about 60% to about 90% of biochar; and from about 10% to about 40% of a binder, preferably from about 75% to about 90% of biochar and from about 10% to about 25% of a binder, more preferably from about 75% to about 85% of biochar and from about 15% to about 25% of a binder, wherein the binder comprises an inorganic component and an organic component. The inorganic component can be sand discarded from an industrial process or hydrated lime, preferably sand discarded from the foundry industry. The inorganic component can also be a combination of discarded sand from an industrial process or hydrated lime with one or more compounds selected from the group consisting of sodium silicate, sodium bentonite, lime (quicklime or hydrated), limestone and Portland cement. The organic component can be starch (in solid, suspended or gelatinized form), tar (heavy bio-oil, obtained from the thermoconversion process of biomass), dextrin, cellulose and derivatives (carboxymethylcellulose—CMC), lignosulfonate, molasses, poly(acrylamide), poly(vinyl alcohol), poly(ethylene), poly(styrene), poly(methacrylate), phenolic resin, epoxy resin or mixtures thereof. The organic component is preferably starch in gel form.

Said binder has a ratio of inorganic component to organic component between approximately 20:80 and approximately 90:10, preferably between approximately 20:80 and approximately 50:50.

In a preferred embodiment of the invention, the high-performance briquette comprises about 85% biochar and about 15% binder; and the binder has an inorganic to organic component ratio of about 20:80.

In another preferred embodiment of the invention, the briquette comprises about 80% biochar and about 20% binder; and the binder has an inorganic to organic component ratio of about 50:50.

Several criteria were considered in selecting the best binders for the briquette formation process, including: the need for mechanical resistance of the briquette, which must maintain its characteristics when placed under pressure or high temperature; and the need for an organic matrix to provide binding and mixing properties, ensuring the briquettes' conformation.

In this context, a survey was conducted on binders including: discarded sand from an industrial process; lime (virgin or hydrated); sodium silicate; sodium bentonite; limestone; Portland cement; starch (in solid, suspended or gelatinized form); tar (heavy bio-oil, obtained from the thermoconversion process of biomass); dextrin; cellulose and derivatives (carboxymethylcellulose—CMC); lignosulfonate; molasses; poly(acrylamide); poly(vinyl alcohol); poly(ethylene); poly(styrene); poly(methacrylate); phenolic resin; epoxy resin; and mixtures thereof. Four of these binders were then selected for testing (lime, discarded foundry sand, tar and starch) and a mixture of discarded foundry sand and starch in gel form proved to be the most satisfactory for achieving all the objectives of this invention. It has been observed that starch in gel form, rather than in its raw (powdered) state, provides better properties for the briquette.

The biochar used in the briquette of this invention is obtained from biomass, which can come from one or more of Eucalyptus spp, Pinus spp, Elephant grass spp, rice husk, Bamboo spp., hedge, green coconut, banana fiber, sugar cane bagasse and/or yerba mate, forestry waste, among others, and/or mixtures thereof. Preferred embodiments of the invention feature biochar obtained from biomass derived from Eucalyptus spp., Pinus spp., Elephant grass spp., or rice husks.

The biochar used in the present invention is preferably produced from the pyrolysis of biomass. The biochar production process can be carried out as is usually known in the state of the art. This process can be carried out in different systems, with industrial furnaces being preferred. Options for industrial furnaces for biochar production include: rotary drum, rectangular masonry, Carboval, among others. For smaller-scale tests, a benchtop pyrolyzer can be used. The main parameter for pyrolysis is the temperature, which should be between about 400 °C and about 700 °C. Preferably, the biochar for use in the briquette of this invention is pyrolyzed at a temperature between about 470 °C and about 650 °C, preferably about 500 °C and about 600 °C, because it involves less energy expenditure and results in a biochar with good properties. Preferably, the pyrolysis performed is a slow pyrolysis, in a fixed bed, with a time of approximately 45 to approximately 120 minutes, preferably approximately 60 to approximately 75 minutes.

This invention also relates to the process of producing the particular biochar briquette with the composition described above. The production of briquettes can be carried out using equipment typically used for briquetting, such as piston briquetting machines, extruder briquetting machines, roller briquetting machines, among others, and comprises the following steps: i) mixing the biochar with a binder; ii) homogenization of the mixture obtained in step i); iii) pressing the material obtained in step ii) in a briquetting machine with hydraulic pressure on the manometer between about 2 MPa (20 bar) and about 7 MPa (70 bar), preferably between about 2 MPa (20 bar) and about 4 MPa (40 bar), pressing pressure on the briquette of about 20.2 MPa (202 bar) to about 70.5 MPa (705 bar), preferably about 20.2 MPa (202 bar) to about 40.3 MPa (403 bar) and pressing time of about 5 to about 15 minutes; iv) curing of the binders from the treatment of the briquettes pressed in step iii) in a circulating air oven or outdoors at a temperature of about 35 °C to about 105 °C for a drying period of about 18 hours to about 70 hours. The mixing and homogenization of steps i) and ii) can be done using mechanical and automated mixing systems.

The briquettes containing the composition of the present invention and produced from the process described above have satisfactory characteristics and properties for total or partial replacement of coke in industrial processes by about 1 to about 80%, about 1 to about 50%, or about 1 to about 25%, such as adequate mechanical strength, calorific value and fixed carbon.

The present invention also relates to the use of the briquette for application in industries including, but not limited to, foundries, steelworks, non-ferrous materials industries, cement industries, thermoelectric power stations, biofuels and power generation industries. Preferably, briquettes are used for total or partial replacement of coke in industrial processes, most preferably in cupola furnaces.

The description given so far of the object of the present invention should be considered only as one possible embodiment or embodiments, and any particular features introduced therein should be understood only as something written to facilitate understanding. As such, they should not be considered as limiting the invention, which is limited to the scope of the claims.

The examples that will be presented illustrate the scope of the products generated by means of the invention proposed here.

### EXAMPLES

Various laboratory tests were carried out to find the best composition for the briquette of this invention. Tests were then carried out to demonstrate the effect and characteristics of the briquettes obtained. The tests of the compositions deemed most suitable and preferred for the invention are presented herein.

To define the best binder components, 4 binders were tested, 2 organic binders—cassava starch (A) and heavy bio-oil (B), and 2 inorganic binders—paint lime (C) and discarded foundry sand (D). The biochar used was obtained from Eucalyptus (spp.) biomass.

Based on these 4 binders, an initial design was made for the biochar/total binder ratio, binder pair, organic:inorganic binder ratio, and pressure range for the mixture's thickening.

With each consolidated step, a new formulation was proposed, aiming to improve the characteristics of the briquettes, mainly the mechanical resistance, since preliminary grip tests, that is, squeezing the briquette by hand, would be an indication of whether it had a minimum resistance that would allow them to be taken to the diametral compression resistance test.

The total mass of the mixture was 40 g per briquette. After defining each formulation to be produced, the process of preparing the raw materials took place, including weighing, homogenization, and finally, briquetting, which involves mixing, homogenization, pressing, and curing, as will be described in more detail below.

Among the binders, heavy bio-oil, paint lime and discarded foundry sand did not require any prior preparation. However, cassava starch was initially tested in its gelatinized form. To do this, the gelatinized starch was prepared with a starch content of between around 10 and 12% w/w.

For the briquetting process, the operating parameters of the briquetting machine were hydraulic pressure on the manometer between 2 MPa (20 bar) and 4 MPa (40 bar) and pressing pressure on the briquette from 20.2 MPa (202 bar) to 40.3 MPa (403 bar), with a pressing time of 10 minutes.

After pressing the briquettes, the binders had to be cured. The briquettes were taken to an air circulation oven at 105 °C for a period of 18 hours.

The mechanical characterization of the briquettes was carried out using the diametral compression tensile test, also known simply as diametral compression. This analysis determines the compressive stress, that is, the compressive force required to break the briquette in relation to the area of the test specimen.

The diametral compression tensile test was based on the ASTM C496/C496M-17:2017 standard and used a 20 kN load cell.

The specimen was placed in the universal testing machine in the longitudinal position. The briquettes were tested until the specimen collapsed, detected by the piece breaking.

The briquettes were evaluated for mechanical characterization (diametral compression), as well as for the characterization of energy properties, including proximate analysis (moisture content, volatile matter, ash, and fixed carbon), higher calorific value (PCS), and combustibility index (IC).

Next, the study of optimal briquette shaping conditions was conducted based on the decision-making process and adjustment of formulations from the evaluations of the mechanical resistance of the briquettes. A preliminary test of grip resistance was performed, where the briquettes were subjected to manual stress, and those that resisted were evaluated by the diametral compression tensile test.

Subsequently, tests were carried out to optimize diametral compression strength, and the best results were obtained for formulations containing a biomass/binder ratio between 85:15 and 75:25 and an inorganic/organic binder ratio between 20:80 and 50:50.

At the end of the processing of all these briquette formulations, it was noted that all of them withstood briquetting, so they were subjected to the diametral compression test. The results of the diametrical compression strength of the sample briquettes are shown in Table 1.

TABLE 1
Diametrical compression strength of
briquettes from formulations AL to AP

| | Biochar/binder | L1/L2 | Compressive strength |
|---|---|---|---|
| Formulation | ratio (%) | ratio (%) | Diametral (MPa) |
| AL | 85-15 | 20-80 | 3.98 ± 0.30 |
| AM | 80-20 | 30-70 | 2.46 ± 0.06 |
| AN | 80-20 | 50-50 | 3.65 ± 0.35 |
| AO | 80-20 | 70-30 | 1.15 ± 0.08 |
| AP | 80-20 | 30-70 | 0.52 ± 0.36 |

L1 = inorganic component (discarded foundry sand was used for these examples)
L2 = organic component (cassava starch was used for these examples)

The formulations considered most suitable from this example were formulations with a biochar content of between 75 and 85% and a binder content of between 15 and 25%, with a binder ratio of between 20:80 and 50:50. The pressure used in the briquetting process was 2.5 MPa (25 bar). The characteristics of the AN formulation are described below as compared to a reference briquette of coke fines, anode fines, and cement:
Mechanical strength: 3.65±0.35 MPa
Moisture: 4.13±0.54%
Volatiles: 22.55±0.55%
Ash: 12.54±0.45%
Fixed carbon: 60.79±0.45%
Combustibility Index: 9.34±0.11 MJ/kg
PCS: 6,197.48±102.19 kcal/kg
Apparent density: 0.67±0.02 g/cm³.

Reference briquette (briquette of coke fines, anode fines and cement).
Mechanical strength: 2.52±0.46 MPa (lateral position)
Humidity: 3.30 0.09%
Volatiles: 13.52 0.98%
Ash: 35.21±2.70%
Fixed carbon: 47.97±1.78%
PCS: 4,914.75±65.25 kcal/kg
Apparent density: 1.17±0.01 g/cm³.

Based on the data and information presented in the text, it is clear that this invention solves the problem of supplying a high-performance biochar briquette capable of totally or partially replacing coke in industrial processes and reusing discarded foundry sand as a component of its binder.

Numerous variations affecting the scope of protection of this application are permitted. This reinforces the fact that this invention is not limited to the particular configurations/concretizations described above.

1. Briquette, characterized in that it comprises:
about 60% to about 90% biochar; and
about 10% to about 40% of a binder,
wherein the binder comprises an inorganic component and an organic component,
wherein the inorganic component comprises waste sand from the foundry industry.

2. Briquette according to claim 1, characterized in that the inorganic component is a mixture of discarded sand from the foundry industry with one or more compounds selected from the group consisting of sodium silicate, sodium bentonite, lime (quicklime or hydrated), limestone and Portland cement.

3. Briquette according to claim 1, characterized in that the organic component is starch (in solid, suspended or gelatinized form), tar (heavy bio-oil, obtained from the thermoconversion process of biomass), dextrin, cellulose and derivatives (carboxymethylcellulose—CMC), lignosulfonate, molasses, poly(acrylamide), poly(vinyl alcohol), poly(ethylene), poly(styrene), poly(methacrylate), phenolic resin, epoxy resin or mixtures thereof.

4. Briquette according to claim 1, characterized in that the organic component is starch in gel form.

5. Briquette according to claim 1, characterized in that the binder has a ratio of the inorganic component to the organic component between about 20:80 and about 90:10, preferably between about 20:80 and about 50:50.

6. Briquette according to claim 1, characterized in that it comprises about 75% to about 90%, preferably about 75% to about 85% of biochar; and about 10% to about 25%, preferably about 15% to about 25% of binder.

7. Briquette according to claim 1, characterized in that the biochar is obtained from biomass derived from one or more of the following: Eucalyptus spp., Pinus spp., Elephant grass spp., rice husk, Bamboo spp., hedge, green coconut, banana fiber, sugarcane bagasse and/or yerba mate and/or mixtures thereof.

8. Briquette according to claim 7, characterized in that the biochar is produced by slow pyrolysis at a temperature between about 400 °C and about 700 °C, preferably between about 470 °C and about 650 °C, more preferably between about 500 °C and about 600 °C in a fixed bed and for a time of about 45 to about 120 minutes, preferably about 60 to about 75 minutes.

9. A briquette production process, as defined in claim 1, characterized in that it comprises the following steps:
i) mixing the biochar with the binder;
ii) homogenization of the mixture obtained in step i);
iii) pressing the material obtained in step ii); and
iv) curing the material obtained in step iii).

10. A briquette production process according to claim 9, characterized in that step iii) of pressing the material is carried out in a briquetting machine with hydraulic pressure on the manometer between about 2 MPa (20 bar) and about 7 MPa (70 bar), preferably between about 2 MPa (20 bar) and about 4 MPa (40 bar), pressing pressure on the briquette of about 20.2 MPa (202 bar) to about 70.5 MPa (705 bar), preferably about 20.2 MPa (202 bar) to about 40.3 MPa (403 bar) and pressing time of about 5 to about 15 minutes.

11. A briquette production process according to claim 9, characterized in that step iv) of curing the material is carried out in a circulating air oven or outdoors at a temperature of about 35 °C to about 105 °C for a drying period of about 18 hours to about 70 hours.

12. Use of a briquette as defined in claim 1, characterized by the fact that it is used in foundry, steel, non-ferrous materials, cement, thermal power plants and/or biofuel and power generation industries.

13. Use according to claim 12, characterized by the fact that it is for total or partial replacement of coke in industrial processes.

14. Use according to claim 13, characterized in that the total or partial replacement of coke is carried out in cupola furnaces.

15. Use according to claim 13, characterized in that the replacement of coke is a partial replacement of about 1 to about 80%.
